(19) United States
(12) Patent Application Publication
(10) Pub. No.: US 2009/0206597 A1
(43) Pub. Date: Aug. 20, 2009

(54) METHOD FOR CONNECTING AN EXHAUST PIPE WITH A FLANGE, FLANGE AND EXHAUST PIPE CONNECTION, AND RESISTANCE PRESSURE WELDING DEVICE

(75) Inventors: GEORG WECKER, Paderborn (DE); Christian Howe, Paderborn (DE); Christof Glodek, Salzkotten (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Benteler Automobiltechnik GmbH, Paderborn (DE)

(21) Appl. No.: 12/370,180

(22) Filed: Feb. 12, 2009

(30) Foreign Application Priority Data
Feb. 20, 2008 (DE) 10 2008 010 192.3

(51) Int. Cl. F16L 27/11; B23K 11/30

(52) U.S. Cl. 285/288.2; 219/66

(57) ABSTRACT

A resistance pressure welding device includes a mounting to support a flange and at least one exhaust pipe to be welded to the flange and arranged in a flange opening of the flange, with the exhaust pipe having an end in the form of an outwardly directed collar. The collar is pressed against the flange by an inner electrode which is movable in an axial direction of the exhaust pipe to press. An outer electrode is placed in spaced-apart surrounding relationship to the inner electrode, and movable in the axial direction of the exhaust pipe against the flange from the same side as the inner electrode so that the welding current can be conducted across the contact surfaces of the collar and the flange.

### CROSS-REFERENCES TO RELATED APPLICATIONS

This application claims the priority of German Patent Application, Serial No. 10 2008 010 192.3, filed Feb. 20, 2008, pursuant to 35 U.S.C. 119(a)-(d), the content of which is incorporated herein by reference in its entirety as if fully set forth herein.

### BACKGROUND OF THE INVENTION

The present invention relates to a method for connecting an exhaust pipe with a flange, to a flange and exhaust pipe connection, and to a resistance pressure welding device.

Nothing in the following discussion of the state of the art is to be construed as an admission of prior art.

Capacitor discharge welding is part of the process group resistance pressure welding (projection welding) and involves capacitor discharge allowing instantaneous high-current pulses (rapid current increase, short welding time, high welding currents). Rapid heat introduction into a joining zone causes quick establishment of the process temperature at the welding spot before the surrounding material undergoes significant heating. Normally, a constant contact pressure is present between the electrode and the workpieces being joined. The electrode tracks hereby a melting of the welding projection.

DE 103 04 086 A1 describes a method of joining tubular elements, whereby a depression or bead is produced on an attachment element or hollow body by plastic deformation of the attachment element or hollow body. A tubular element is then placed into the depression or placed upon the hollow body and aligned in relation to the attachment element or hollow body and subsequently connected with the attachment element through material connection such as resistance or capacitor discharge welding.

Manufacture of exhaust manifolds with a pertaining flange is normally realized by gas-shielded metal-arc welding, whereby the melting welding wire is continuously tracked in varying speed. At the same time, inert gas is directed to the welding spot via a nozzle. This process suffers shortcomings because the workpiece surfaces become contaminated by splashing weld or scale formation inside and outside the tubes. These contaminations can be removed only through complicated refinishing operations. The heat introduction may also cause warping in the joining zone, especially because the flanges generally have a much greater wall thickness than the exhaust pipes being welded thereto. Process reliability of the inert gas welding process requires careful supervision especially because of the different material thicknesses. When exhaust manifold with several exhaust pipes are involved, several welding operations are required which can normally be executed only in sequence in view of the limited accessibility. As a result, long cycle times are encountered.

Resistance pressure welding has been proven difficult to use in tasks, when an exhaust pipe is intended for connection to a flange or several exhaust pipes are intended for connection to a common flange because only one side of the flange is accessible for welding operations.

It would therefore be desirable and advantageous to address prior art shortcomings.

### SUMMARY OF THE INVENTION

According to one aspect of the present invention, a method of connecting an exhaust pipe with a flange includes the steps of arranging an exhaust pipe in a flange opening of a flange (this step is called “calibrating”), with an outwardly directed collar at an end of an exhaust pipe bearing upon the flange, placing the flange with the arranged exhaust pipe therein in a resistance pressure welding device, pressing the collar of the exhaust pipe against the flange by an inner electrode of the resistance pressure welding device, forcing an outer electrode of the resistance pressure welding device in surrounding relationship to the inner electrode into contact with the flange, and conducting a welding current across contact surfaces of the collar and the flange that are pressed to one another to weld the contact surfaces together.

The term “inner electrode” is used in the description to indicate the presence of an outer electrode in surrounding relationship to the inner electrode. Although the inner electrode may also engage the collar, it is also conceivable that the inner electrode is only movable in axial direction, when a collar is involved which extends at an angle of 90° in relation to the central length axis of the exhaust pipe. Thus, the inner electrode rests virtually flatly upon a radial plane of the collar extending in radial direction.

Compared to gas-shielded metal-arc welding, the method according to the present invention has short cycle times, causes minimal heat introduction in the joining zone so that the joining process can be carried out in the absence of significant warping, reduces scale formation on surfaces near the joining zone, and reduces splashing. The method according to the present invention is applicable not only for connecting circular-symmetric tube geometries but also for oval-symmetric tube geometries Thus, the flange opening may be round or oval or even have the shape of an oblong hole.

Advantageously, the outer electrode can move towards the workpieces to be connected from the same side as the inner electrode. In view of the virtually ring-shaped configuration of the outer electrode, the welding current needs to travel only along a very short current path within the workpieces. As a result, the heat impact zone is very small.

According to another advantageous feature of the present invention, the collar can be pressed by the inner electrode into a circumferential depression at a mouth of the flange opening. As a result, a flange and exhaust pipe connection can be implemented in which the collar does not project beyond the flange opening so that a planar surface of the flange can be realized for attachment to the motor block

In view of the one-sided contact of the flange and exhaust pipe by the inner and outer electrodes which are electrically insulated from one another, it becomes possible to weld several exhaust pipes simultaneously in a resistance pressure welding device with the flange. There is no need to take into account the geometry of the bottom side of the flange that is normally difficult to access. In other words, the design of the pipeline can be constructed irrespective of the connection technology.

According to another aspect of the present invention, a combined flange and exhaust pipe connection includes a flange having a flange opening, and an exhaust pipe received in the flange opening and having one end formed with an outwardly directed collar in line contact with the flange before being welded together as a welding current is conducted therethrough.

As the collar is in line contact with the flange before the welding current is conducted through, the joining zones are rapidly heated. The line contact ensures in resistance pressure welding high current densities and a rapid melting of the contact surfaces. Unlike a spot contact, the line contact also makes it possible that the entire circumferential zone of the collar is welded to the flange so as to ensure the desired exhaust-gas tightness.

According to another feature of the present invention, the flange may be provided with a depression arranged in a mouth of the flange opening to provide a diametrically enlarged gradation of the flange opening. In this way, the collar can also be welded in such a manner that it does not extend beyond the flange opening. The gradation of the flange opening may have a conical configuration, e.g. the mouth may have in relation to a central length axis of the flange opening a cone angle which increases in a direction of the mouth of the flange opening. As a result, the mouth is in effect rounded. In this case, a substantially straight collar can necessarily only come into line contact with the rounded mouth zone. Suitably, the collar of the exhaust pipe is angled at an angle between 30° and 60° in relation to a central length axis of the exhaust pipe. Currently preferred is an angle of 45° in relation to the central length axis of the exhaust pipe. This is also true when the mouth-side depression is a diametrically enlarged gradation of the flange opening. In this case, the collar of the exhaust pipe may be angled at an angle of 90° in relation to a central length axis of the exhaust pipe. When the collar extends, however, at an angle between 30° and 60° in relation to the central length axis, the collar rests upon the transition of the flange opening to the gradation and thus is also in line contact with the flange, without the exhaust pipe projecting beyond the mouth or flange opening.

Of course, the present invention does not preclude the possibility to have the collar extend beyond the flange opening in order to be pressed flatly against the mouth-side surface of the flange, when the collar is angled by 90°, for example. In this case, the flange or the collar may be provided with an annular ridge to establish a line contact between the flange and the collar.

According to yet another aspect of the present invention, a resistance pressure welding device for connecting an exhaust pipe with a flange includes a mounting supporting a flange and at least one exhaust pipe to be welded to the flange and arranged in a flange opening of the flange, with the exhaust pipe having an end in the form of an outwardly directed collar, an inner electrode movable in an axial direction of the exhaust pipe to press the collar against the flange, and an outer electrode in spaced-apart surrounding relationship to the inner electrode, with the outer electrode being movable in the axial direction of the exhaust pipe for electrically contacting the flange.

A resistance pressure welding device according to the present invention enables a welding of exhaust pipes with a flange, without guiding electrodes on both opposite sides of the flange. This virtually one-sided welding is made possible by the particular electrode geometry, in particular as a result of the outer, ring-shaped electrode. The distance of the electrodes, which are insulated from one another, is as small as possible to keep the heat impact zone to a minimum. To attain an even welding across the entire circumference of the collar, the distance between the inner electrode and the outer electrode is kept constant. With respect to their spatial disposition, the electrodes are concentric to one another. The term “concentric” is hereby to be understood as being independent from the shape of the electrodes, especially because the flange opening can be round, oval, or even polygonal. A shape in the form of an oblong hole is also possible.

According to another feature of the present invention, the inner electrode may be pressed by a spring force against the collar. In other words, the electrode is guided initially close to the collar, with the feed motion being slightly continued so that a spring arranged between the inner electrode and an abutment can be maintained under tension. As the contact zones melt, the collar is kept pressed by the spring force against the flange so that the contact zone between the components expands and an adjustable minimum welding seam width is attained. In other words, the inner electrode tracks during welding. This can be achieved constructively in a particular simple manner by providing a guide shaft which is sized to extend through the inner electrode.

According to another advantageous feature of the present invention, an abutment may be linked to the guide shaft, and a spring extending between the abutment and the inner electrode allows a movement of the inner shaft in response to a movement of the guide shaft. The spring may be a helical compression spring in surrounding relationship to the guide shaft.

There is no need to track the ring-shaped outer electrode during the welding process so that the inner electrode may also be movable in relation to the outer electrode.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a sectional view of a resistance pressure welding device according to the present invention for making a connection between a flange and exhaust pipe;

FIG. 2 is an enlarged detailed view of the area encircled in FIG. 1 and marked “B”;

FIG. 3 is a schematic sectional view of a variation of an electrode for making a connection between a flange and exhaust pipe;

FIG. 4 is a schematic sectional view of four exhaust pipes on a flange before resistance pressure welding;

FIGS. 5a, b are schematic illustrations of two different embodiments of flange openings, one with elliptic cross section and one in the form of an oblong hole; and

FIGS. 6a-f show six variants V1-V6 of flange and exhaust pipe connections.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

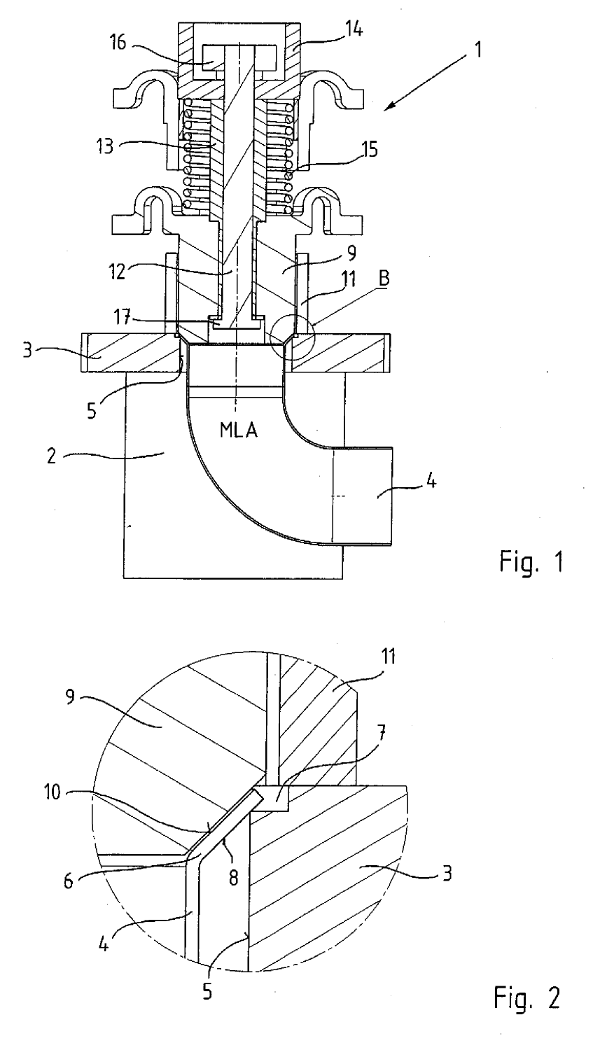

Turning now to the drawing, and in particular to FIG. 1, there is shown a sectional view of a resistance pressure welding device according to the present invention, generally designated by reference numeral 1 for making a connection between a flange 3 and exhaust pipe 4. The resistance pressure welding device 1 includes a mounting 2 for support of the flange 3. The flange 3 is provided for attachment of the exhaust pipe 4 to a motor block. By way of example, FIG. 1 shows a curved exhaust pipe which is to be welded to the flange 3. The exhaust pipe 4 is hereby received in a flange opening 5. The flange 3 may have further flange openings 5 for placement of additional exhaust pipes 4 in a same manner. The exhaust pipe 4 is formed with one widened end to define a collar 6. The collar 6 has an outer diameter which is greater than an inner diameter of the flange opening 5. As shown in FIG. 1 and in particular in FIG. 2, which is an enlarged detailed view of the area encircled in FIG. 1 and marked “B”, the collar 6 does not project beyond the flange opening 5 as a result of the presence of a mouth-side depression 7 in the form of a diametrically enlarged gradation of the flange opening 5. As a result, the outer side 8 of the collar 6 contacts the flange 3 in the form of a line contact. The flange 3 and the exhaust pipe 4 (or exhaust pipes) are precisely aligned and calibrated before the welding operation. Then, an inner electrode 9 is pressed against the inner side 10 of the collar 6. In the non-limiting example, shown here, the collar 6 extends at an angle of 45° in relation to the central length axis MLA of the exhaust pipe 4. In other words, the collar 6 has a virtually funnel-shaped configuration. Thus, the inner electrode 9 has a lower end provided with a circumferential 45° bevel to complement the orientation of the collar 6. The inner electrode 9 is surrounded in the form of a ring by an outer electrode 11 which contacts the flange 3 so that a welding current can be conducted through the region or contact surfaces of the collar 6 and the flange 3, pressed to one another.

As can be seen from FIG. 2, the distance between the outer electrode 11 and the inner electrode 9 is very small. The distance is basically constant. The outer electrode 11 and the inner electrode 9 are arranged in concentric relationship.

The inner electrode 9 is traversed by a guide shaft 12 which extends in the direction of the central length axis MLA. The guide shaft 12 is electrically insulated against the inner electrode 9 by an insulant 13. The guide shaft 12 extends to an abutment 14 arranged above the inner electrode 9. The abutment 14 is also movable axially in relation to the guide shaft 12.

The guide shaft 12 is surrounded by a spring 15 in the form of a helical compression spring which is tensed between the abutment 14 and the inner electrode 9. As the abutment 14 is lowered, the inner electrode 9 is urged by the spring force of the spring 15 against the collar 6. After welding and tracking the inner electrode 6 in axial direction, the abutment 14 is raised again so that engagement pieces 16, 17 arranged at opposite ends of the guide shaft 12, respectively, are able to lift the inner electrode 9.

Although not shown in detail, the outer electrode 11 is also raised and lowered, which may also be implemented under the influence of a spring force. During welding, however, the outer electrode 11 does not track a movement of the inner electrode 6 because the outer electrode 11 is provided only for introduction of the welding current into the flange 3.

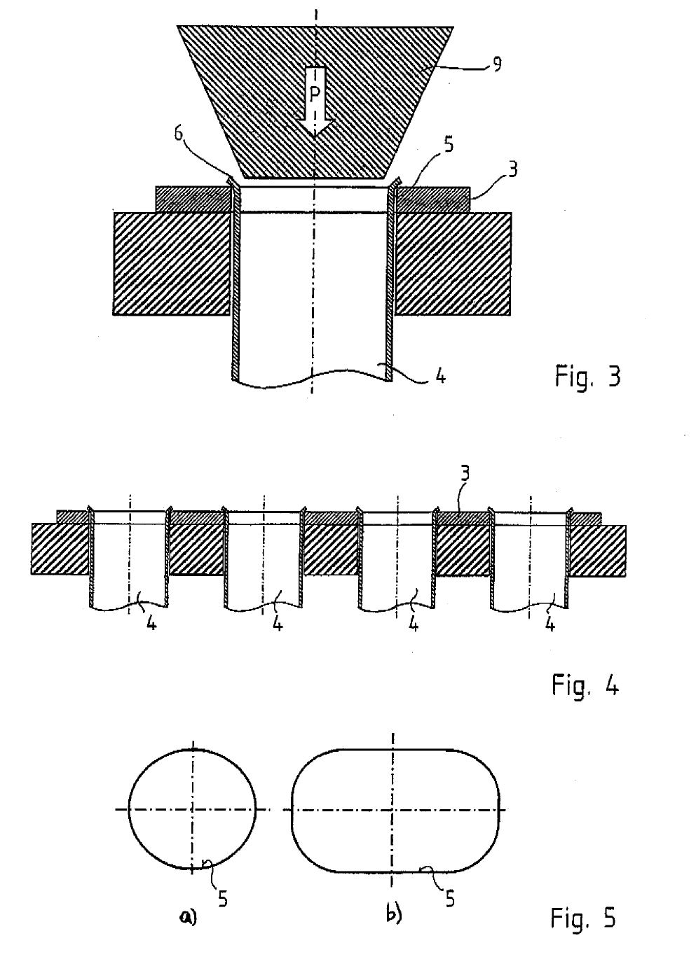

Referring now to FIG. 3, there is shown a schematic sectional view of another possibility to provide a connection between a flange 3 and exhaust pipe 4. Parts corresponding with those in FIGS. 1 and 2 are denoted by identical reference numerals and not explained again. The description below will center on the differences between the embodiments. In this embodiment, provision is made for the exhaust pipe 4 to rest on the rim of a cylindrical flange opening 5 via a line contact. The exhaust pipe 4 can be welded to the flange 3 via an inner electrode 9 which is lowered in a direction of arrow P. For ease of illustration, the outer electrode 11 is not shown in FIG. 3, but, analog to the embodiment of FIG. 1, is placed upon the flange 3 also through movement in the direction of arrow P in order to introduce the welding current. Arrow P designates the joining direction in which pressure is applied.

FIG. 3 also shows the connection of a single exhaust pipe 4 with the flange 3. In principle, the present invention allows also the realization of several such flange-exhaust pipe connections either in sequence or at the same time, as shown in FIG. 4, which illustrates a flange 3 with a total of four flange openings 5 for placement of exhaust pipes 4 in one-to-one correspondence.

FIGS. 5a, b show different cross sectional geometries of exhaust pipes 4 and flange openings 5. The flange opening 5 on the left-hand side (FIG. 5a) is round, whereas the flange opening on the right-hand side (FIG. 5b) is configured as oblong hole.

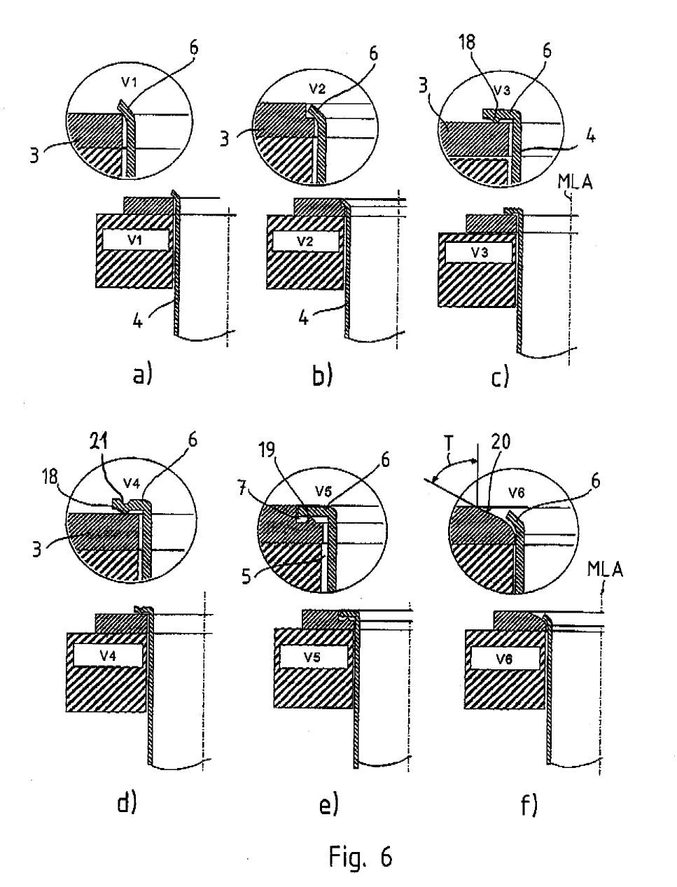

FIGS. 6a-f show six variants V1-V6 of flange and exhaust pipe connections to depict different configurations of the collars 6 and flanges 3 and to depict options as to how the collars 6 can be connected to the flange.

Variant V1 according to FIG. 6a corresponds to the one of FIGS. 3 and 4. Variant V2 according to FIG. 6b corresponds to the one of FIG. 1. The variant V3 according to FIG. 6c shows a configuration in which the collar 6 is angled outwards by 90° in relation to the central length axis MLA and is formed on a side in confronting relationship to the flange 3 with an annular ridge 18 which is in line contact with the flange 3. During welding, the flange-distal side of the collar 6 is pressed down so as to establish the welding zone in the area of the annular ridge 18.

The variant V4 according to FIG. 6d differs from the variant V3 of FIG. 6c by the configuration of the annular ridge 18 in the form of a projection directed in axial direction so that the flange-proximal side of the collar is formed with a circumferential groove 21.

The variant V5 according to FIG. 6e shows the presence of an annular ridge 19 which is formed on the flange 3 instead of the collar 6. In this example, the annular ridge 19 is located in a mouth-side depression 7 in the form of a diametrically enlarged stepped bore opposite to the flange opening 5. The annular ridge 19 points in axial direction. The collar 6 is angled by 90° in relation to the central length axis MLA and is received completely in the depression 7.

The variant V6 according to FIG. 6f shows an embodiment in which the collar 6 is angled by 45° in relation to the central length axis MLA, with the flange opening 5 having a mouth 20 in the form of a funnel angle T which increases in the direction of the mouth of the flange opening 5. As a result, the mouth 20 has a rounded cross section which can be brought into a line contact with a substantially straight collar 6 for subsequent welding by means of resistance pressure welding. Like the variants V2 and V5, the collar 6 is located also in this variant completely within the flange opening 5 of the flange 3 and thus, does not project beyond the flange 3. This facilitates attachment of the flange 3 to an unillustrated motor block.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method of connecting an exhaust pipe with a flange, comprising the steps of:
arranging an exhaust pipe in a flange opening of a flange, with an outwardly directed collar at an end of an exhaust pipe bearing upon the flange;
placing the flange with the arranged exhaust pipe therein in a resistance pressure welding device;
pressing the collar of the exhaust pipe against the flange by an inner electrode of the resistance pressure welding device;
forcing an outer electrode of the resistance pressure welding device in surrounding relationship to the inner electrode into contact with the flange; and
conducting a welding current across contact surfaces of the collar and the flange that are pressed to one another to weld the contact surfaces together.

2. The method of claim 1, wherein the collar is pressed by the inner electrode into a circumferential depression at a mouth of the flange opening.

3. The method of claim 1, wherein a plurality of exhaust pipes are arranged in the flange and placed into the resistance pressure welding device.

4. A combined flange and exhaust pipe connection, comprising:
a flange having a flange opening; and
an exhaust pipe received in the flange opening and having one end formed with an outwardly directed collar in line contact with the flange before being welded together as a welding current is conducted therethrough.

5. The connection of claim 4, wherein the collar is sized not to extend beyond the flange opening.

6. The connection of claim 4, wherein the flange is provided with a depression arranged in a mouth of the flange opening to provide a diametrically enlarged gradation of the flange opening.

7. The connection of claim 6, wherein the gradation of the flange opening has a conical configuration.

8. The connection of claim 7, wherein the mouth has in relation to a central length axis of the flange opening a cone angle which increases in a direction of the mouth of the flange opening.

9. The connection of claim 4, wherein the collar of the exhaust pipe is angled at an angle between 30° and 60° in relation to a central length axis of the exhaust pipe.

10. The connection of claim 4, wherein the collar of the exhaust pipe is angled at an angle of 40° in relation to a central length axis of the exhaust pipe.

11. The connection of claim 4, wherein the collar of the exhaust pipe is angled at an angle of 90° in relation to a central length axis of the exhaust pipe.

12. The connection of claim 4, wherein the flange includes an annular ridge against which the collar is pressed.

13. The connection of claim 4, wherein the collar includes an annular ridge which is pressed against the flange.

14. The connection of claim 4, wherein the flange opening has a cross section which is round, oval, or shaped in the form of an oblong hole.

15. A resistance pressure welding device for connecting an exhaust pipe with a flange, comprising:
a mounting supporting a flange and at least one exhaust pipe to be welded to the flange and arranged in a flange opening of the flange, with the exhaust pipe having an end in the form of an outwardly directed collar;
an inner electrode movable in an axial direction of the exhaust pipe to press the collar against the flange; and
an outer electrode in spaced-apart surrounding relationship to the inner electrode, said outer electrode being movable in the axial direction of the exhaust pipe for electrically contacting the flange.

16. The resistance pressure welding device of claim 15, wherein the inner electrode is spaced from the outer electrode by a constant distance.

17. The resistance pressure welding device of claim 15, wherein the inner electrode is urged against the collar by a spring force.

18. The resistance pressure welding device of claim 15, further comprising a guide shaft sized to extend through the inner electrode.

19. The resistance pressure welding device of claim 18, further comprising an abutment linked to the guide shaft, and a spring extending between the abutment and the inner electrode to allow a movement of the inner shaft in response to a movement of the guide shaft.

20. The resistance pressure welding device of claim 19, wherein the spring is a helical compression spring in surrounding relationship to the guide shaft.

21. The resistance pressure welding device of claim 19, wherein the guide shaft has one end in the form of an engagement member in engagement with a confronting side of the inner electrode, and another end in the form of an engagement member in engagement with the abutment.
